(19) United States
(12) Patent Application Publication
(10) Pub. No.: US 2026/0112152 A1
(43) Pub. Date: Apr. 23, 2026

(54) VIDEO ANALYSIS SYSTEM, VIDEO ANALYSIS PROGRAM, AND TRAINING SYSTEM

(71) Applicant: TOYOTA JIDOSHA KABUSHIKI KAISHA, Aichi-ken (JP)

(72) Inventors: Quan KONG, Tokyo-to (JP); Norimasa KOBORI, Tokyo-to (JP)

(21) Appl. No.: 19/337,979

(22) Filed: Sep. 24, 2025

(30) Foreign Application Priority Data
Oct. 22, 2024 (JP) 2024-185703

(51) Int. Cl. G06V 10/774; G06F 40/40; G06V 10/82; G06V 20/40; G06V 20/70

(52) U.S. Cl. CPC G06V 10/7747; G06F 40/40; G06V 10/82; G06V 20/41; G06V 20/70

(57) ABSTRACT

A video analysis system has a large language model (LLM). A spatial-temporal scene graph is a scene graph indicating a spatial-temporal relationship between objects in a video. A graph feature is a feature of the spatial-temporal scene graph. Input information input to the LLM includes at least the graph feature and a prompt. Description information output from the LLM gives a description of the video in response to the prompt. The LLM is pretrained to receive the input information and output the description information. The video analysis system is configured to: receive the prompt regarding a target video from a user; acquire the input information regarding the target video; and input the input information regarding the target video into the LLM to acquire the description information regarding the target video.

### CROSS-REFERENCES TO RELATED APPLICATION

The present disclosure claims priority to Japanese Patent Application No. 2024-185703, filed on Oct. 22, 2024, the contents of which application are incorporated herein by reference in their entirety.

### TECHNICAL FIELD

The present disclosure relates to a technique for analyzing a video to acquire description information regarding the video.

### BACKGROUND ART

Patent Literature 1 discloses an object detection system. The object detection system includes an object detection model for detecting an object from an image. The object detection model is generated in advance by machine learning. The object detection system detects an object from an image by utilizing the object detection model.

Non-Patent Literature 1 discloses a graph structure encoder that encodes a spatial-temporal scene graph to acquire a graph token being a feature of the spatial-temporal scene graph.

### List of Related Art

Patent Literature 1: Japanese Laid-Open Patent Application No. JP-2024-76159

Non-Patent Literature 1: Seongjun Yun et al., Graph Transformer Networks, 33rd Conference on Neural Information Processing Systems (NeurIPS 2019), 2019.

### SUMMARY

It is desired to understand a spatial-temporal relationship between objects in a video.

An object of the present disclosure is to provide a technique capable of facilitating understanding of a spatial-temporal relationship between objects in a video.

A first aspect relates to a video analysis system.

The video analysis system includes:
one or more processors; and
one or more storage devices configured to store a large language model (LLM).

A spatial-temporal scene graph is a scene graph indicating a spatial-temporal relationship between objects in a video.

A graph feature is a feature of the spatial-temporal scene graph.

Input information input to the LLM includes at least the graph feature and a prompt.

Description information output from the LLM gives a description of the video in response to the prompt.

The LLM is pretrained to receive the input information and output the description information.
the one or more processors are configured to:
receive the prompt regarding a target video from a user;
acquire the input information regarding the target video; and
input the input information regarding the target video into the LLM to acquire the description information regarding the target video.

A second aspect relates to a video analysis program including a large language model (LLM).

A spatial-temporal scene graph is a scene graph indicating a spatial-temporal relationship between objects in a video.

A graph feature is a feature of the spatial-temporal scene graph.

Input information input to the LLM includes at least the graph feature and a prompt.

Description information output from the LLM gives a description of the video in response to the prompt.

The LLM is pretrained to receive the input information and output the description information.

The video analysis program, when executed by a computer, causes the computer to execute:
receiving the prompt regarding a target video from a user;
acquiring the input information regarding the target video; and
inputting the input information regarding the target video into the LLM to acquire the description information regarding the target video.

A third aspect relates to a training system for training a large language model (LLM).

The training system includes:
one or more processors; and
one or more storage devices configured to store the LLM.

A spatial-temporal scene graph is a scene graph indicating a spatial-temporal relationship between objects in a video.

A graph feature is a feature of the spatial-temporal scene graph.

A text feature is a feature of a text describing an attribute of each node in the spatial-temporal scene graph.

An aligned graph feature is the graph feature where a correlation between the graph feature and the text feature for each node is equal to or higher than a predetermined level.

Input information input to the LLM includes at least the aligned graph feature and a prompt.

Description information output from the LLM gives a description of the video in response to the prompt.
the one or more processors are configured to:
acquire the aligned graph feature; and
execute an LLM training process that trains, based on the aligned graph feature, the LLM so as to receive the input information and output the description information.

According to the present disclosure, a spatial-temporal scene graph is used for acquiring a description of a video. The spatial-temporal scene graph is a scene graph indicating a spatial-temporal relationship between objects in the video. A graph feature is a feature of the spatial-temporal scene graph. By referring to the graph feature, the LLM is able to output a description information that describes the spatial-temporal relationship between the objects in the video. This makes it possible to facilitate understanding of the spatial-temporal relationship between the objects in the video.

### BRIEF DESCRIPTION OF DRAWINGS

FIG. 1 is a conceptual diagram for explaining an overview of a video analysis system according to an embodiment of the present disclosure;

FIG. 2 is a block diagram for explaining a variety of processes for acquiring a variety of features (tokens) according to the embodiment;

FIG. 3 is a conceptual diagram for explaining an alignment process in a training phase according to the embodiment;

FIG. 4 is a conceptual diagram for explaining an outline of an LLM training process in the training phase according to the embodiment;

FIG. 5 is a conceptual diagram for explaining a first training process in the LLM training process according to the embodiment;

FIG. 6 is a conceptual diagram for explaining a second training process in the LLM training process according to the embodiment;

FIG. 7 is a block diagram for explaining an inference phase according to the embodiment; and

FIG. 8 is a block diagram illustrating an example of a hardware configuration of the video analysis system according to the embodiment.

### DETAILED DESCRIPTION

Embodiments of the present disclosure will be described with reference to the accompanying drawings.

### 1. OVERVIEW

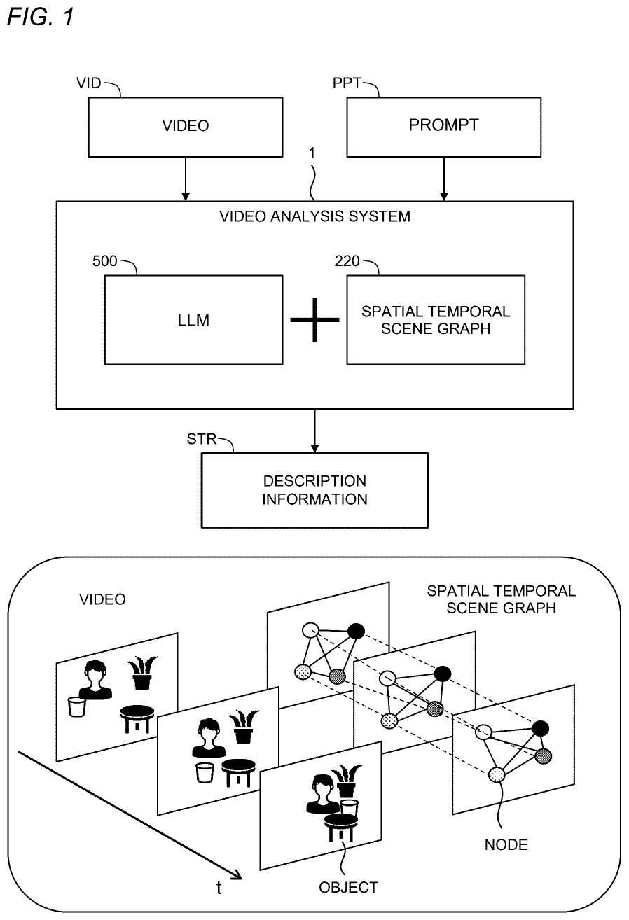

FIG. 1 is a conceptual diagram for explaining an overview of a video analysis system 1 according to the present embodiment. The video analysis system 1 acquires a video VID taken by a camera or the like and analyzes the video VID.

More specifically, the video analysis system 1 is provided with a large language model (LLM) 500. A user inputs a prompt PPT that instructs a task related to the video VID to the video analysis system 1. The video analysis system 1 receives the prompt PPT input by the user and inputs the prompt PPT to the LLM 500. In response to the prompt PPT, the LLM 500 outputs a reply (answer) to the prompt PPT. The reply to the prompt PPT includes description information STR that gives a description of the video VID. The video analysis system 1 presents, to the user, text information or audio information corresponding to the description information STR output from the LLM 500. That is, the video analysis system 1 presents the description information STR regarding the video VID to the user in a text format or an audio format, in response to the prompt PPT input by the user.

Here, let us consider understanding a spatial-temporal relationship between objects (instances) in the video VID. Conventionally, techniques such as a multi-modal LLM and Video Transformer are known, but understanding of a spatial-temporal relationship between objects in a video VID has been insufficient. The present embodiment proposes a technique capable of facilitating understanding of a spatial-temporal relationship between objects in a video VID.

According to the present embodiment, a “spatial-temporal scene graph (ST-SG) 220” is used for facilitating understanding of a spatial-temporal relationship between objects in a video VID. The spatial-temporal scene graph 220 is a scene graph that spatially and temporally represents a scene shown in the video VID, and is generated from the video VID. More specifically, the video VID includes a series of frames (images) that are temporally consecutive. A scene graph representing a scene shown in each frame indicates objects in the each frame and relationships (e.g., positional relationships, action relationships, and the like) between the objects in the each frame. Nodes in the scene graph correspond to the objects in the frame. Edges in the scene graph indicate the relationships (e.g., positional relationships, action relationships, and the like) between the nodes (i.e., between the objects). The scene graphs obtained for respective frames are associated with each other on a time axis to form the spatial-temporal scene graph 220. It can also be said that the spatial-temporal scene graph 220 is a scene graph that spatially and temporally indicates the objects in the video VID and the spatial-temporal relationship between the objects in the video VID.

As described above, the spatial-temporal scene graph 220 generated from the video VID indicates the spatial-temporal relationship between the objects in the video VID. The LLM 500 is configured to be able to output the description information STR describing the spatial-temporal relationship between the objects in the video VID by referring to feature information of the spatial-temporal scene graph 220. That is, the video analysis system 1 is configured to be able to acquire the description information STR describing the spatial-temporal relationship between the objects in the video VID by combining the LLM 500 and the spatial-temporal scene graph 220. This makes it possible to facilitate understanding of the spatial-temporal relationship between the objects in the video VID. That is, it is possible to understand the spatial-temporal relationship between the objects in the video VID more accurately and more precisely.

Various examples are conceivable as applications of the video analysis system 1 according to the present embodiment. For example, a spatial-temporal search, a spatial-temporal visual question answering (VQA), an LLM Grounded Digital Twin, and the like are conceivable as the applications of the video analysis system 1 according to the present embodiment.

### 2. TRAINING PHASE

Hereinafter, a method of training the LLM 500 will be described in detail. The video analysis system 1 may serve as a “training system” that trains the LLM 500.

### 2-1. Acquisition of Various Features

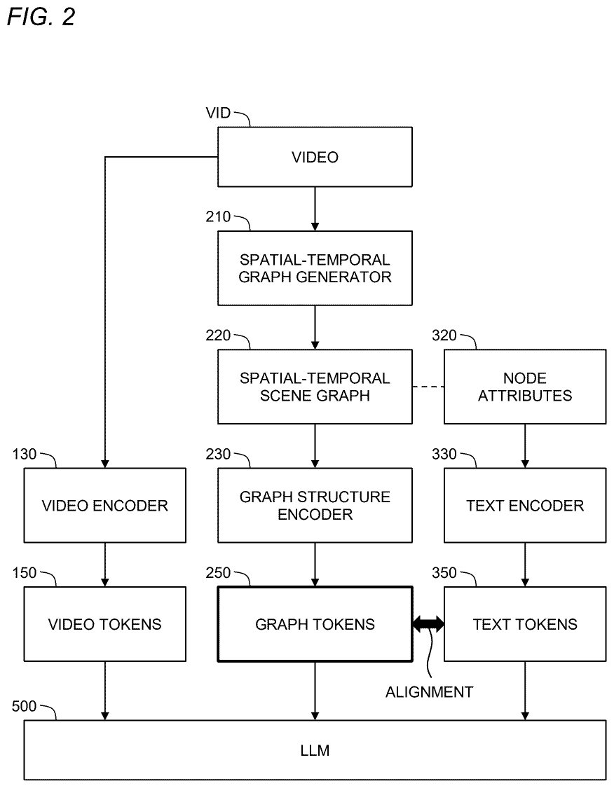

FIG. 2 is a block diagram for explaining a variety of processes for acquiring a variety of features (tokens) to be input to the LLM 500. It should be noted that not raw data itself but features (tokens) generated from the raw data are input to the LLM 500.

### 2-1-1. Video Feature (Video Token)

The video analysis system 1 (the training system) includes a video encoder 130. The video encoder 130 encodes the video VID to generate a video feature 150 that is a feature of the video VID. The video encoder 130 is trained so as to receive the video VID and output the video feature 150. Such the video encoder 130 is an existing technique. For example, existing Vision Transformer is used as the video encoder 130. The video feature 150 is hereinafter referred to as a video token 150.

### 2-1-2. Graph Feature (Graph Token)

The video analysis system 1 (the training system) includes a spatial-temporal graph generator 210. The spatial-temporal graph generator 210 executes a scene graph generation (SGG) process that generates a spatial-temporal scene graph 220 from the video VID. The SGG is a well-known technique. As described above, the spatial-temporal scene graph 220 spatially and temporally represents a scene shown in the video VID. More specifically, the spatial-temporal scene graph 220 indicates objects in the video VID and a spatial-temporal relationship between the objects in the video VID. The nodes in the spatial-temporal scene graph 220 correspond to the objects in the video VID. The edges in the spatial-temporal scene graph 220 indicate the relationships (e.g., positional relationships, action relationships, and the like) between the nodes (i.e., between the objects).

Moreover, the video analysis system 1 (the training system) includes a graph structure encoder 230. The graph structure encoder 230 encodes the spatial-temporal scene graph 220 to generate a graph feature 250 that is a feature of the spatial-temporal scene graph 220. More specifically, the graph feature 250 is generated for each node in the spatial-temporal scene graph 220. That is, the graph feature 250 is a feature of each node in the spatial-temporal scene graph 220. Here, the graph feature 250 of each node is generated so as to reflect not only a feature of each node but also a relationship with an adjacent node. The graph structure encoder 230 is trained so as to receive the spatial-temporal scene graph 220 and output the graph feature 250. Such the graph structure encoder 230 is an existing technique. For example, Graph Transformer described in the above-mentioned Non-Patent Literature 1 is used as the graph structure encoder 230. The graph feature 250 is hereinafter referred to as a graph token 250.

### 2-1-3. Text Feature (Text Token)

A node attribute 320 is text information describing an attribute of each node in the spatial-temporal scene graph 220. In other words, the node attribute 320 is text information describing an attribute of each object in the video VID. The node attribute 320 is generated for each node (object). For example, the node attribute 320 regarding a person includes a triplet basic configuration such as <node1: person> <edge1: holding> <node2: cafe_cup>. Such the node attribute 320 is generated, for example, simultaneously when the above-described spatial-temporal scene graph 220 is generated. In the spatial-temporal scene graph 220, the node attribute 320 may be defined as one of the metadata. In this manner, the node attribute 320 for each node is prepared in advance before training.

The video analysis system 1 (the training system) includes a text encoder 330. The text encoder 330 encodes the node attribute 320 to generate a text feature 350 that is a feature of the node attribute 320. The text feature 350 is generated for each node in the spatial-temporal scene graph 220. The text encoder 330 is trained so as to receive the node attribute 320 and output the text feature 350. Such the text encoder 330 is an existing technique. For example, existing Transformer is used as the text encoder 330. The text feature 350 is hereinafter referred to as a text token 350.

### 2-2. Alignment Process

An existing LLM can recognize the text token 350, but does not support the graph token 250. In view of the above, according to the present embodiment, the graph token 250 and the text token 350 are associated with each other in advance so that the LLM 500 is able to recognize the graph token 250. In other words, a process of correlating the graph token 250 and the text token 350 is performed in advance. In other words, a process of aligning the graph token 250 and the text token 350 is performed. The process of aligning the graph tokens 250 and the text tokens 350 is hereinafter referred to as an “alignment process.”

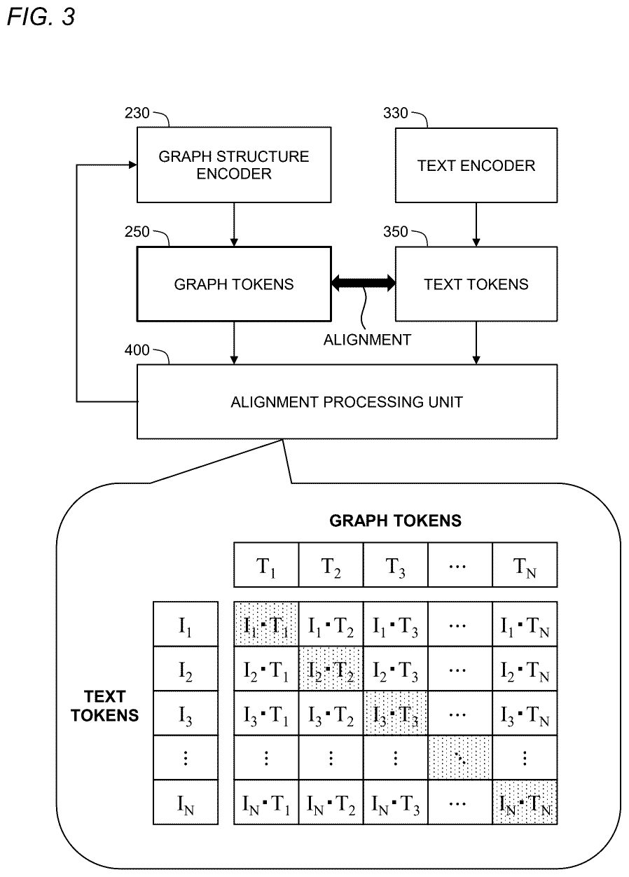

FIG. 3 is a conceptual diagram for explaining the alignment process. The video analysis system 1 (the training system) includes an alignment processing unit 400. As described above, the graph structure encoder 230 receives the spatial-temporal scene graph 220 and outputs the graph token 250. The graph token 250 is generated for each node in the spatial-temporal scene graph 220. The text token 350 is also generated for each node in the spatial-temporal scene graph 220. The alignment processing unit 400 acquires the graph token 250 and the text token 350 for each node. Then, the alignment processing unit 400 trains the graph structure encoder 230 such that the graph token 250 and the text token 350 for each node in a feature space become as close as possible. In other words, the alignment processing unit 400 trains the graph structure encoder 230 such that a correlation between the graph token 250 and the text token 350 for each node in the feature space becomes as high as possible. That is, the alignment processing unit 400 trains the graph structure encoder 230 such that the correlation between the graph token 250 and the text token 350 for each node in the feature space becomes equal to or higher than a predetermined level.

An example of the graph tokens 250 and text tokens 350 also is conceptually illustrated in FIG. 3. It is assumed that the number of nodes in the spatial-temporal scene graph 220 is N. The graph tokens 250 for the N nodes are denoted by T₁ to T_{N}, respectively. The text tokens 350 for the N nodes are denoted by I₁ to I_{N}, respectively. Correlations between the N graph tokens T₁ to T_{N} and the N text tokens I₁ to I_{N} are represented by an N×N matrix. Each diagonal component Iᵢ□Tᵢ (i=1 to N) of the N×N matrix represents the correlation between the graph token Ti and the text token Ii for the node i. Ideally, the graph structure encoder 230 is trained such that all the diagonal components Iᵢ□Tᵢ (i=1 to N) become 1.0. Typically, the graph structure encoder 230 is trained such that the diagonal components Iᵢ□Tᵢ (i=1 to N) become equal to or higher than a predetermined level.

The graph token 250 obtained by the graph structure encoder 230 after the alignment process is completed is hereinafter referred to as an “aligned graph token 250A” for convenience sake. The correlation between the aligned graph token 250A and the text token 350 for each node is equal to or higher than a predetermined level. That is, the aligned graph token 250A is aligned with the text token 350. It can also be said that the aligned graph token 250A can be equated to the text token 350.

### 2-3. LLM Training Process

As a result of the alignment process described above, the aligned graph token 250A becomes aligned with the text token 350. Subsequently, the video analysis system 1 (the training system) trains the LLM 500 such that the LLM 500 is able to output appropriate description information STR (see FIG. 1) in response to the prompt PPT while referring to the aligned graph token LLM 500. This process is hereinafter referred to as an LLM training process. It should be noted that the LLM training process here is not performed on a not-yet-trained LLM from the beginning, but is fine tuning of an existing LLM that has been trained to some extent.

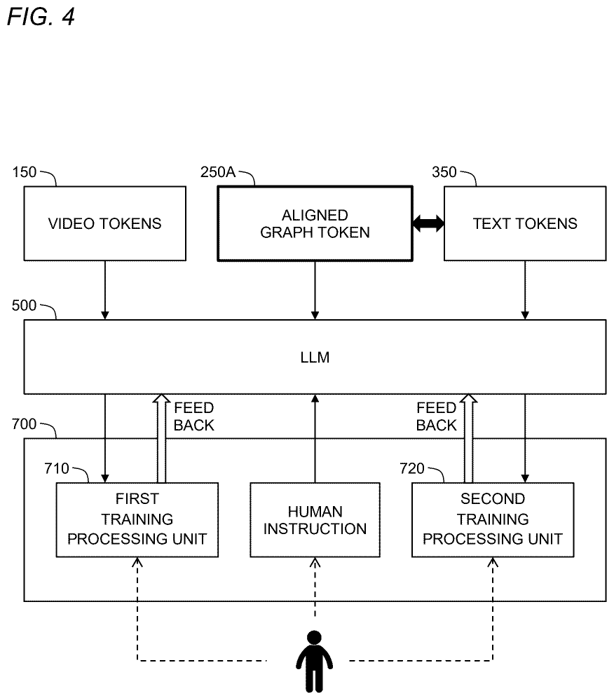

FIG. 4 is a conceptual diagram for explaining an outline of the LLM training process according to the present embodiment. The video analysis system 1 (the training system) includes a training processing unit 700 that executes the LLM training process.

For example, the training processing unit 700 performs instruction tuning of the LLM 500. Input information that is input to the LLM 500 includes various tokens (the video token 150, the aligned graph token 250A, and the text token 350) and an instruction from a human. The training processing unit 700 inputs the input information to the LLM 500 and receives a reply that is output from the LLM 500 in response to the input information. A human or a machine determines whether the reply output from the LLM 500 is appropriate or not (OK/NG). The training processing unit 700 performs the instruction tuning of the LLM 500 by feeding back a result of the determination (i.e., appropriateness of the reply from the LLM 500) to the LLM 500.

According to the present embodiment, the LLM training process includes two-stage training processes. The first-stage training process is hereinafter referred to as a “first training process.” The second-stage training process is hereinafter referred to as a “second training process.” The second training process is performed after the first training process. The training processing unit 700 includes a first training processing unit 710 that executes the first training process and a second training processing unit 720 that executes the second training process.

### 2-3-1. First Training Process

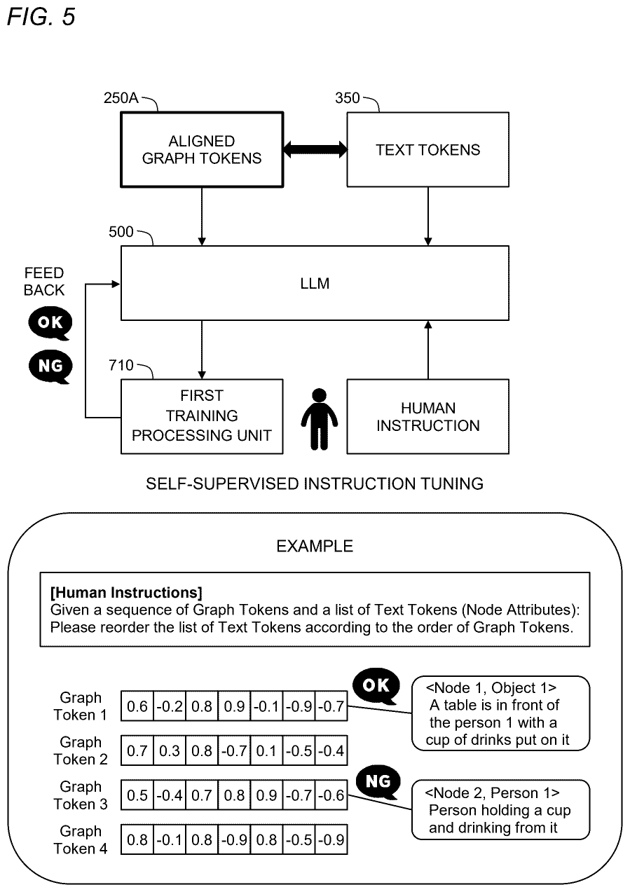

FIG. 5 is a conceptual diagram for explaining the first training process in the LLM training process. The first training process is for making the LLM 500 recognize a correspondence relationship between the aligned graph token 250A and the text token 350. The first training processing unit 710 performs instruction tuning of the LLM 500 such that the LLM 500 is able to recognize the correspondence relationship between the aligned graph token 250A and the text token 350. For example, the first training processing unit 710 performs self-supervised instruction tuning.

Input information that is input into the LLM 500 includes the aligned graph token 250A for each node, the text token 350 for each node, and an instruction from a human. For example, the aligned graph token 250A for each node and the text token 350 for each node are provided in a list format. The instruction from the human is, for example, “Based on the list of graph tokens for each node and the list of text tokens for each node, please reorder the order of the text tokens so as to match the order of the graph tokens.”

The first training processing unit 710 inputs the input information to the LLM 500. In accordance with the instruction from the human, the LLM 500 performs reordering of the text tokens 350. The LLM 500 outputs a result of the reordering as a reply. That is, the LLM 500 outputs a reply that indicates a correspondence relationship between the aligned graph tokens 250A and the text tokens 350. The first training processing unit 710 receives the reply output from the LLM 500. A human or a machine determines whether the reply output from the LLM 500 is appropriate or not (OK/NG). The first training processing unit 710 performs the instruction tuning of the LLM 500 by feeding back a result of the determination (i.e., appropriateness of the reply from the LLM 500) to the LLM 500. That is, the first training processing unit 710 fine-tunes some of parameters of the LLM 500 through the instruction tuning.

As an example, FIG. 5 shows a list of the aligned graph tokens 250A for four nodes. Each aligned graph token 250A is represented by a set of multiple features. For example, the LLM 500 answers “the text token for the node 1 corresponds to the graph token for the node 1 (Graph Token 1).” This answer is correct, and thus the first training processing unit 710 feeds back “OK” to the LLM 500. As another example, the LLM 500 answers “the text token for the node 2 corresponds to the graph token for the node 3 (Graph Token 3).” This answer is incorrect, and thus the first training processing unit 710 feeds back “NG” to the LLM 500.

The first training process described above enables the LLM 500 to recognize the correspondence relationship between the aligned graph token 250A and the text token 350.

### 2-3-2. Second Training Process

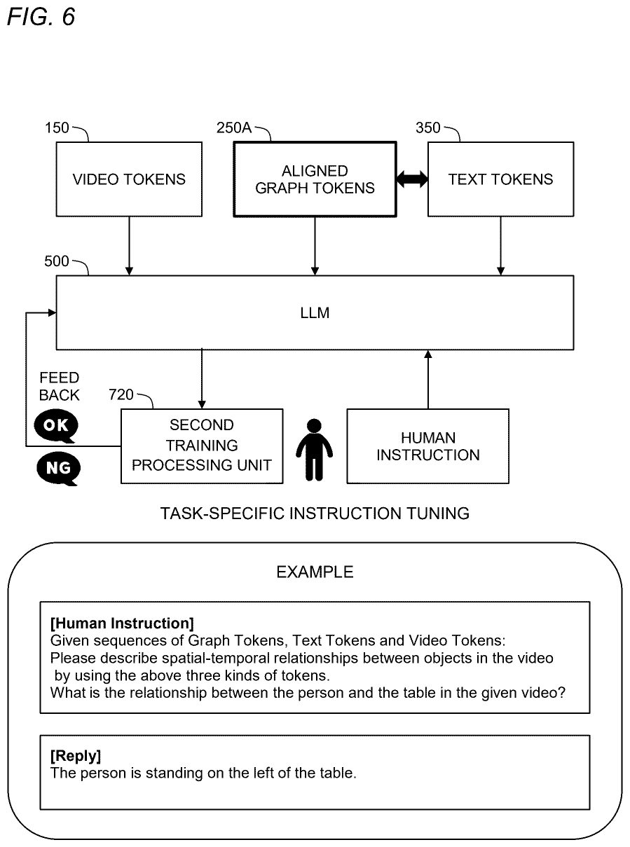

FIG. 6 is a conceptual diagram for explaining the second training process in the LLM training process. The second training process is for causing the LLM 500 to perform a task desired by the user. The second training processing unit 720 performs instruction tuning of the LLM 500 (Task-specific Instruction Tuning) such that the LLM 500 is able to output an appropriate reply (answer) to the prompt PPT (task) input from the user.

Input information that is input into the LLM 500 includes the video token 150, the aligned graph token 250A, the text token 350, and an instruction from a human. The instruction from the human is, for example, “Use the input tokens to explain a spatial-temporal relationship between objects in the video.” As another example, the instruction from the human may be “Use the input tokens to verbalize a relationship between a person and a desk.” As yet another example, the instruction from the human may be “Use the input tokens to express a human's motion in a language.”

The second training processing unit 720 inputs the input information to the LLM 500. The LLM 500 generates a reply (answer) to the instruction from the human, based on the video token 150, the aligned graph token 250A, and the text token 350. More specifically, the LLM 500 generates a reply (answer) according to the video token 150 and the aligned graph token 250A while referring to the text token 350. The reply to the instruction from the human includes the description information STR that gives a description of the video VID. That is, the LLM 500 receives the input information and outputs the description information STR as a reply. The second training processing unit 720 receives the description information STR output from the LLM 500. A human or a machine determines whether the description information STR output from the LLM 500 is appropriate or not (OK/NG). The second training processing unit 720 performs the instruction tuning of the LLM 500 by feeding back a result of the determination (i.e., appropriateness of the description information STR output from the LLM 500) to the LLM 500. In this manner, the second training processing unit 720 performs tuning of the LLM 500 so as to be able to cope with the task.

### 2-3-3. Modification Example

As a modification example, the video token 150 may be excluded from the input information input into the LLM 500. That is, the input information that is input into the LLM 500 may include only the aligned graph token 250A, the text token 350, and the instruction from the human.

However, when the input information includes the video token 150 as well, performance of the LLM 500 becomes higher and thus accuracy of the description information STR output from the LLM 500 also becomes higher. As such, it is preferable that the input information includes the video token 150.

### 3. INFERENCE PHASE

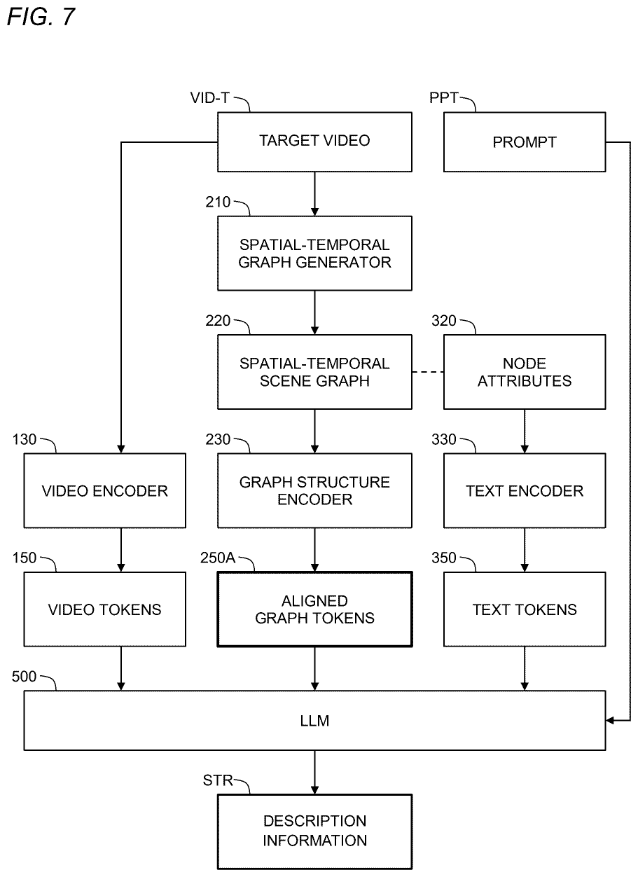

FIG. 7 is a block diagram for explaining an inference phase according to the present embodiment. Hereinafter, the video VID to be analyzed in the inference phase is referred to as a “target video VID-T” for convenience sake. The video analysis system 1 acquires the target video VID-T.

The video encoder 130, the spatial-temporal graph generator 210, the graph structure encoder 230, and the text encoder 330 are the same as those described in the above Section 2. Based on the target video VID-T, the video analysis system 1 acquires the video token 150, the aligned graph token 250A, and the text token 350 regarding the target video VID-T. That is, the video analysis system 1 inputs the target video VID-T to the video encoder 130 to acquire the video token 150 regarding the target video VID-T. In addition, the video analysis system 1 inputs the target video VID-T to the spatial-temporal graph generator 210 to acquire the spatial-temporal scene graph 220 regarding the target video VID-T. The node attribute 320 is also generated together with the spatial-temporal scene graph 220. Furthermore, the video analysis system 1 acquires the aligned graph token 250A regarding the target video VID-T by inputting the spatial-temporal scene graph 220 regarding the target video VID-T to the graph structure encoder 230. Furthermore, the video analysis system 1 acquires the text token 350 regarding the target video VID-T by inputting the node attribute 320 regarding the target video VID-T to the text encoder 330.

In addition, the video analysis system 1 receives a prompt PPT regarding the target video VID-T from the user. The prompt PPT instructs a task related to the target video VID-T. For example, the prompt PPT is such as “Use the input tokens to explain a spatial-temporal relationship between objects in the video.” As another example, the prompt PPT may be “Use the input tokens to verbalize a relationship between a person and a desk.” As yet another example, the prompt PPT may be “Use the input tokens to express a human's motion in a language.”

Input information that is input into the LLM 500 includes the video token 150, the aligned graph token 250A, the text token 350, and the prompt PPT. The description information STR output from the LLM 500 is information that gives a description of the target image VID-T in response to the prompt PPT. For example, the description information STR is information describing a spatial-temporal relationship between objects in the target video VID-T. The video analysis system 1 acquires the description information STR regarding the target video VID-T by inputting the input information regarding the target video VID-T into the LLM 500. The video analysis system 1 presents text information or audio information corresponding to the description information STR regarding the target video VID-T to the user. That is, the video analysis system 1 presents the description information STR regarding the target video VID-T to the user in a text format or an audio format in response to the prompt PPT input by the user.

As a modification example, the video token 150 may be excluded from the information input into the LLM 500. That is, the input information that is input into the LLM 500 may include only the aligned graph token 250A, the text token 350, and the prompt PPT.

However, when the input information includes the video token 150 as well, performance of the LLM 500 becomes higher and thus accuracy of the description information STR output from the LLM 500 also becomes higher. As such, it is preferable that the input information includes the video token 150.

### 4. EXAMPLE OF HARDWARE CONFIGURATION OF VIDEO ANALYSIS SYSTEM

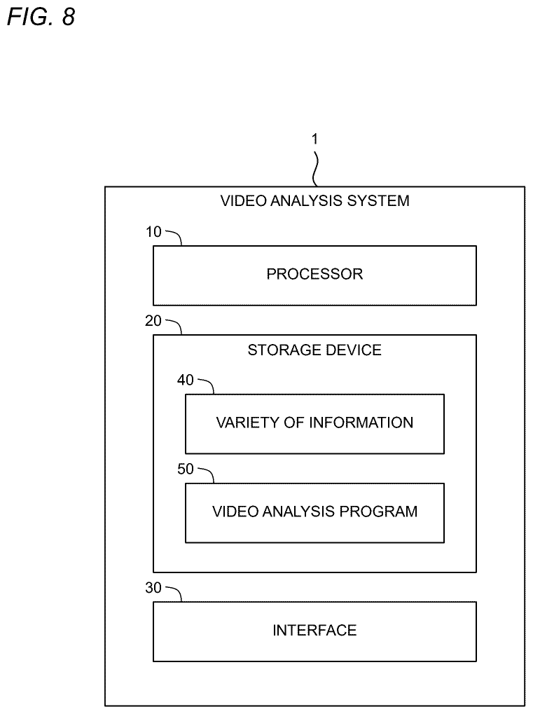

FIG. 8 is a block diagram illustrating an example of a hardware configuration of the video analysis system 1 according to the present embodiment. The video analysis system 1 may be configured by a single information processing device or may be configured by a combination of a plurality of information processing devices. More specifically, the video analysis system 1 includes one or more processors 10 (hereinafter simply referred to as a “processor 10”), one or more storage devices 20 (hereinafter simply referred to as a “storage device 20”), and one or more interfaces 30 (hereinafter simply referred to as an “interface 30”).

The processor 10 executes a variety of processing. Examples of the processor 10 include a general-purpose processor, a special-purpose processor, a central processing unit (CPU), a graphics processing unit (GPU), an application specific integrated circuit (ASIC), a field-programmable gate array (FPGA), and the like. The processor 10 may be referred to as processing circuitry.

The storage device 20 stores a variety of information 40. Examples of the storage device 20 include a volatile memory, a nonvolatile memory, a hard disk drive (HDD), a solid state drive (SSD), and the like. The variety of information 40 include the video encoder 130, the video token 150, the spatial-temporal graph generator 210, the spatial-temporal scene graph 220, the graph structure encoder 230, the graph token 250, the aligned graph token 250A, the node attribute 320, the text encoder 330, the text token 350, the LLM 500, the description information STR, and the like.

The interface 30 receives a variety of data from the outside and outputs a variety of data to the outside. For example, the interface 30 includes a communication interface. The interface 30 may include a user interface that provides information to the user and receives an input from the user. Examples of the user interface include a touch panel, a display, a speaker, and the like.

The processor 10 acquires the video VID via the interface 30. The processor 10 receives the instruction and the prompt PPT from the user via the interface 30 (the user interface). The processor 110 executes the training process described in the above Section 2. Moreover, the processor 110 executes the inference process described in the above Section 3. The processor 110 presents the description information STR to the user via the interface 30 (the user interface). The description information STR may be presented in a text format or may be presented in an audio format.

The processor 10 may execute a video analysis program 50 that is a computer program. In this case, the functions of the video analysis system 1 are implemented by a cooperation of the processor 10 executing the video analysis program 50 and the storage device 20. The video analysis program 50 is stored in the storage device 20. The video analysis program 50 may be recorded on a non-transitory computer-readable recording medium. The video analysis program 50 includes the LLM 500. The video analysis program 50 may include the spatial-temporal graph generator 210. The video analysis program 50 may include the video encoder 130. The video analysis program 50 may include the graph structure encoder 230. The video analysis program 50 may include the text encoder 330.

What is claimed is:

1. A video analysis system comprising:
one or more processors; and
one or more storage devices configured to store a large language model (LLM), wherein
a spatial-temporal scene graph is a scene graph indicating a spatial-temporal relationship between objects in a video,
a graph feature is a feature of the spatial-temporal scene graph,
input information input to the LLM includes at least the graph feature and a prompt,
description information output from the LLM gives a description of the video in response to the prompt,
the LLM is pretrained to receive the input information and output the description information, and
the one or more processors are configured to:
receive the prompt regarding a target video from a user;
acquire the input information regarding the target video; and
input the input information regarding the target video into the LLM to acquire the description information regarding the target video.

2. The video analysis system according to claim 1, wherein
the one or more processors are further configured to present text information or audio information corresponding to the description information regarding the target video to the user.

3. The video analysis system according to claim 1, wherein
a video feature is a feature of the video, and
the input information includes the video feature, the graph feature, and the prompt.

4. The video analysis system according to claim 1, wherein
the one or more storage devices are further configured to store a graph structure encoder that is trained to receive the spatial-temporal scene graph and output the graph feature, and
the one or more processors are further configured to:
acquire the spatial-temporal scene graph regarding the target video; and
input the spatial-temporal scene graph regarding the target video into the graph structure encoder to acquire the graph feature regarding the target video.

5. A video analysis program including a large language model (LLM),
a spatial-temporal scene graph is a scene graph indicating a spatial-temporal relationship between objects in a video,
a graph feature is a feature of the spatial-temporal scene graph,
input information input to the LLM includes at least the graph feature and a prompt,
description information output from the LLM gives a description of the video in response to the prompt,
the LLM is pretrained to receive the input information and output the description information, and
the video analysis program, when executed by a computer, causes the computer to execute:
receiving the prompt regarding a target video from a user;
acquiring the input information regarding the target video; and
inputting the input information regarding the target video into the LLM to acquire the description information regarding the target video.

6. The video analysis program according to claim 5, wherein
the video analysis program further causes the computer to execute presenting text information or audio information corresponding to the description information regarding the target video to the user.

7. The video analysis program according to claim 5, wherein
a video feature is a feature of the video, and
the input information includes the video feature, the graph feature, and the prompt.

8. A training system for training a large language model (LLM),
the training system comprising:
one or more processors; and
one or more storage devices configured to store the LLM, wherein
a spatial-temporal scene graph is a scene graph indicating a spatial-temporal relationship between objects in a video,
a graph feature is a feature of the spatial-temporal scene graph,
a text feature is a feature of a text describing an attribute of each node in the spatial-temporal scene graph,
an aligned graph feature is the graph feature where a correlation between the graph feature and the text feature for each node is equal to or higher than a predetermined level,
input information input to the LLM includes at least the aligned graph feature and a prompt,
description information output from the LLM gives a description of the video in response to the prompt, and
the one or more processors are configured to:
acquire the aligned graph feature; and
execute an LLM training process that trains, based on the aligned graph feature, the LLM so as to receive the input information and output the description information.

9. The training system according to claim 8, wherein
a video feature is a feature of the video, and
the input information includes the video feature, the aligned graph feature, and the prompt.

10. The training system according to claim 8, wherein
the one or more storage devices are further configured to store a graph structure encoder that is trained to receive the spatial-temporal scene graph and output the graph feature, and
the one or more processors are further configured to:
execute an alignment process that trains the graph structure encoder such that the correlation between the graph feature and the text feature for each node becomes equal to or higher than the predetermined level; and
acquire the graph feature obtained by the graph structure encoder after the alignment process, as the aligned graph feature.

11. The training system according to claim 8, wherein
the LLM training process includes a first training process, and
the first training process includes performing instruction tuning of the LLM such that the LLM recognizes a correspondence relationship between the aligned graph feature and the text feature.

12. The training system according to claim 11, wherein
the LLM training process further includes a second training process after the first training process,
the input information further includes the text feature, and
the second training process includes performing instruction tuning of the LLM such that the LLM receives the input information and outputs the description information.
